(19) United States
(12) Patent Application Publication
(10) Pub. No.: US 2009/0305907 A1
(43) Pub. Date: Dec. 10, 2009

(54) Method for Creating Distinct Nitrocellulose-based Pads on a Substrate

(76) Inventors: James Russell Webster, Hsinchu (TW); Ko-Yuan Tseng, Taipei (TW); Shaw-Tzu Wang, Taipei (TW)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/478,726

(22) Filed: Jun. 4, 2009

Related U.S. Application Data
(60) Provisional application No. 61/058,916, filed on Jun. 4, 2008.

(51) Int. Cl. C40B 50/00

(52) U.S. Cl. 506/23

(57) ABSTRACT

A method for defining arrays of specific areas of porous nitrocellulose based pads on a substrate directly without the need for removal of nitrocellulose in unwanted regions; covering said substrate with a removable frame constructed out of 3-4 mm silicone rubber; using a dispensing station, consisting of a XYZ robot, multi-channel syringe pump, and dispensing head comprised of an array of flat hypodermic syringe needles, to spread the nitrocellulose-based solution in a programmed fashion onto said substrate covered by said removable frame.

### CROSS REFERENCE TO RELATED APPLICATION

This application claims the benefit of priority under 35 U.S.C. 119(e) to the filing date of U.S. provisional patent application No. 61/058,916 entitled “Method for creating distinct nitrocellulose-based pads on a substrate” which was filed on Jun. 4, 2008, and are incorporated herein by reference.

### FIELD OF THE INVENTION

The present invention relates generally to methods for defining arrays of specific areas of porous nitrocellulose based pads without the need for removal of nitrocellulose in unwanted regions. Specifically, the present invention is related to the creation of distinct nitrocellulose-based pads by utilizing a dispensing station programmed to spread the solution in the predefined pad shape. More specifically, the present invention is related to creating distinct nitrocellulose-based pads by placing a removable frame on top of the substrate and utilizing a programmed dispensing station to define the pad shape.

### BACKGROUND OF THE INVENTION

Nitrocellulose is a common material used for binding of proteins for biochemical assays such as antibody-antigen binding reactions. Nitrocellulose membranes are utilized to detect the presence and/or concentration level of certain biological material by immobilizing specific proteins. Nitrocellulose membranes currently are the main support matrix for “rapid test” products such as over the counter urine tests (U.S. Pat. No. 6,818,455 & U.S. Pat. No. 5,602,040) as well as a variety of blood tests. These rapid test products readily useable by an unskilled person and which preferably merely requires that some portion of the product contacts with the sample (e.g. a urine stream in the case of a pregnancy or ovulation test) and thereafter no further actions are required by the user before an analytical result can be observed. Typically, the analytical result should be observable within a matter of minutes following sample application, e.g. ten minutes or less.

The high protein binding capacity and reliable “wicking” ability of the membranes has secured their use in the market for many years. With the advent of microarray techniques there has been interest in providing nitrocellulose films on glass slide substrates [1,2]. Most commonly such films have a high degree of porosity, are typically white, and are usually provided as defined regions on a glass slide. Since the films are porous, defined regions are necessary to perform multiple experiments on 1 slide without cross-contamination. Examples of such slides are available from GE Healthcare (Whatman FAST Slides), Grace Bio Labs (ONCYTE Slides) and more recently by Schott. In most cases the nitrocellulose film is applied to the glass using a spin casting method. Following casting of the porous film, the nitrocellulose is removed in unwanted areas to define regions or “pads”. Alternatively a transparent nitrocellulose film (U.S. Pat. No. 6,861,251) is available from GenTel Biosciences (PATH Slides). This is a non-porous film and therefore defined regions are not necessary. In most cases slides are mounted in a frame that facilitates the processing of multiple assays at one time such as in U.S. Pat. No. 7,063,979.

Although the technology has been fairly mature as to casting porous film, the casting process of nitrocellulose in precisely defined regions or “pads” provides ample room for improvement. Specifically, it is unresolved that an effective, fast, efficient and economical method to cast nitrocellulose in specific, defined locations is needed to reduce the costs of preparing nitrocellulose film on a substrate wherein such substrate is capable of performing multiple immunoassay experiments. Such a method would eliminate existing cumbersome methods of extracting and removing nitrocellulose from undesirable locations and thereby decrease the cost of producing nitrocellulose membranes.

### REFERENCES

1. Cytometrically coherent transfer of receptor proteins on microporous membrane. BioTechniques Vol. 11, No 3: 352-361, 1991.
2. High Definition cell analysis in situ using microporous films. Cell Vision, vol. 2, No 6: 499-590, 1995.

### OBJECT OF THE INVENTION

It is an object of this invention to provide a method to accurately and efficiently cast defined arrays of porous nitrocellulose pads directly onto a substrate without the need for removal of nitrocellulose in unwanted regions.

It is further an object of this invention to provide a method to produce a nitrocellulose slide in a cost effective manner.

It is further an object of this invention to provide an apparatus to produce a nitrocellulose slide in a cost effective manner.

### SUMMARY OF THE INVENTION

The invention describes a method for defining arrays of specific areas of porous nitrocellulose based pads on a substrate directly without the need for removal of nitrocellulose in unwanted regions by using a dispensing station equipped with a pump compatible with solvents and spreading the nitrocellulose based solution with the dispensing head in a programmed fashion define the pad shape.

In one embodiment, nitrocellulose based solutions composed of a single solvent are pumped and dispensed by the dispensing station. In another embodiment, nitrocellulose based solutions composed of solvent mixtures are pumped and dispensed by the dispensing station.

In one embodiment, the dispensing station is an XYZ robot and a pump. In yet another embodiment it further comprises of a multi-channel syringe pump to perform high accuracy, multi-channel dispensing. In one embodiment, it further comprises of glass, gas-tight syringes.

In one embodiment, the dispensing head is comprised of an array of flat hypodermic syringe needles.

In one other embodiment, the substrate is held at a constant temperature by a hot/cold plate.

In yet one other embodiment, the substrate is a microtiter plate.

In another aspect the invention is a method for creating distinct nitrocellulose-based pads on a substrate by: using a dispensing station; providing a removable frame on top of the substrate in such a way as to slow the drying rate of the pad; dispensing nitrocellulose based solution through the frame onto the substrate; and spreading the dispensed solution with the dispensing head in a programmed fashion to define the pad shape.

In one embodiment, the dispensing station is an XYZ robot and a pump. In one other embodiment, if further comprises of a multi-channel syringe pump to perform high accuracy, multi-channel dispensing. In yet one other embodiment, it further comprises of glass, gas-tight syringes.

In one embodiment, the dispensing head is comprised of an array of flat hypodermic syringe needles. In another embodiment, the substrate is held at a constant temperature by a hot/cold plate. In yet another embodiment, the substrate is a microtiter plate. In one embodiment, the removable frame is constructed out of silicone rubber. In yet one other embodiment, the removable frame is 3-4 mm thick. In yet another embodiment, the removable frame is 1 to 5 mm thick. In yet another embodiment, the removable frame is 3.5 mm thick. In yet another embodiment, the substrate is a non-planar substrate. In yet one other embodiment, the non-planar substrate is a flat bottom 96-well micro-titer plate.

### BRIEF DESCRIPTION OF THE DRAWINGS

FIG. 1—A schematic of the dispensing system utilizing an XYZ robot, 8 channel dispensing head and stationary substrate with removable frame.

FIG. 2—A representation of the motion of the dispensing needle in relation to the substrate that will spread the solution to form a pad.

FIG. 3—A photograph of a 3 substrates with nitrocellulose pads created using the disclosed method.

FIG. 4—A plot of the transmission percentage of a row of 9, 5.5 mm diameter nitrocellulose pads created using the disclosed method but not using the removable frame.

FIG. 5—A plot of the transmission percentage of a row of 12, 5.5 mm diameter nitrocellulose pads created using the disclosed method when using the removable frame.

FIG. 6—A photograph of a 96-well microtiter plate where the bottom of the wells are coated with nitrocellulose.

### DETAILED DESCRIPTION OF EMBODIMENTS

The invention describes a method for defining arrays of specific areas of porous nitrocellulose based pads on a substrate directly without the need for removal of nitrocellulose in unwanted regions. Nitrocellulose based solutions composed of single solvents or solvent mixtures are pumped and dispensed through a multi-channel head containing an array of flat syringe needles. Nearly any pump compatible with the solvents can be used. For high accuracy, multi-channel dispensing, a syringe pump using glass, gas-tight syringes is preferred. The position of the syringe needle above the substrate is programmed using an XYZ robot. During and/or after dispensing of the nitrocellulose based solution the syringe needle is programmed to move such that its motion defines the desired shape and size of the nitrocellulose pad. Such motion allows the resulting wetted substrate area to be much larger than the viscosities and contact angles alone would naturally allow. Dispensing of the solution can be done intermittently in single or multiple shots or continuously depending on the desired outcome.

In the event that uniform whiteness and porosity are desired, a frame constructed from silicone rubber is placed on top of the substrate prior to dispensing. The softness of the rubber ensures that a good seal is formed between the frame and the substrate. A 3 or 4 mm thick silicone rubber frame with 7 mm diameter holes at 9 mm pitch is suitable. The solvent vapors from the nitrocellulose solution are typically heavier than air and when the frame is present will accumulate above the dispensed solution enough to slow down the drying rate of the nitrocellulose solution and produce pads with improved uniformity. When employing the frame, a cantilever-type XYZ robot is preferred so that the substrate is stationary throughout the process and solvent vapors within the frame are undisturbed.

Non-planar substrates can also be coated with nitrocellulose using the method of this invention if the area to which the nitrocellulose coating is to be applied is sufficiently flat. A preferred non-planar substrate is that of a flat bottom, 96-well micro-titer plate. The bottom of the wells can be coated using the method of this invention. In this case the removable frame is not necessary as the depth of the plate provides the same function by sufficiently accumulating solvent vapors to produce uniform whiteness and porosity.

Often it is advantageous to control the temperature of the substrate to reduce or enhance the drying rate and also improve the variability from piece-to-piece. Placing the substrate on a water-cooled/heated platen is the preferred method for controlling the substrate temperature. nitrocellulose pads when not using the cover. A row of 9 pads was scanned using a transparency scanner and the data converted to transmission percentage. The nitrocellulose pads show peaks and valleys within the pad itself, typically with the center at a higher percentage transmission.

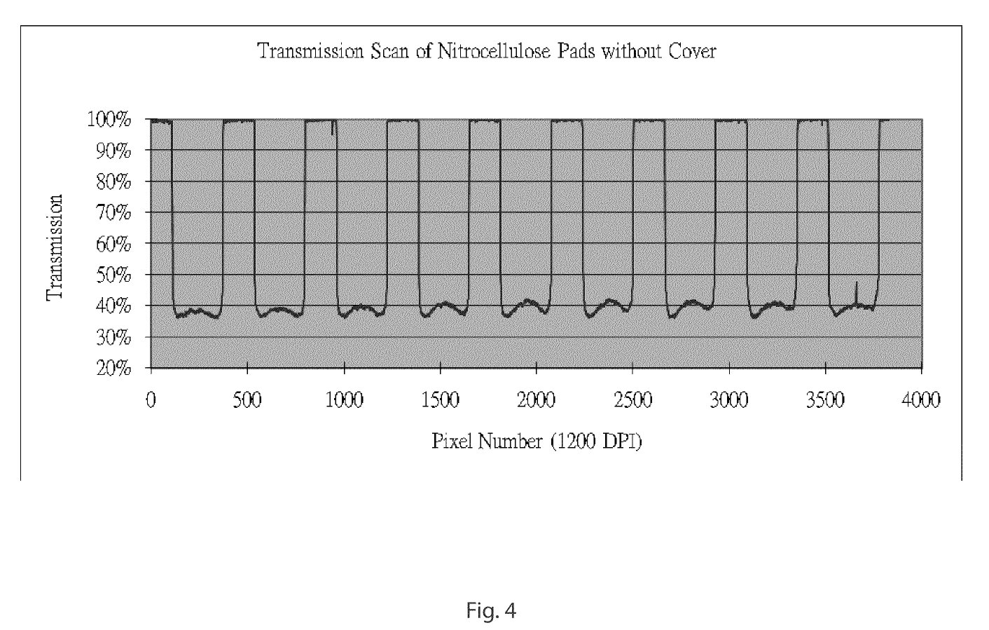

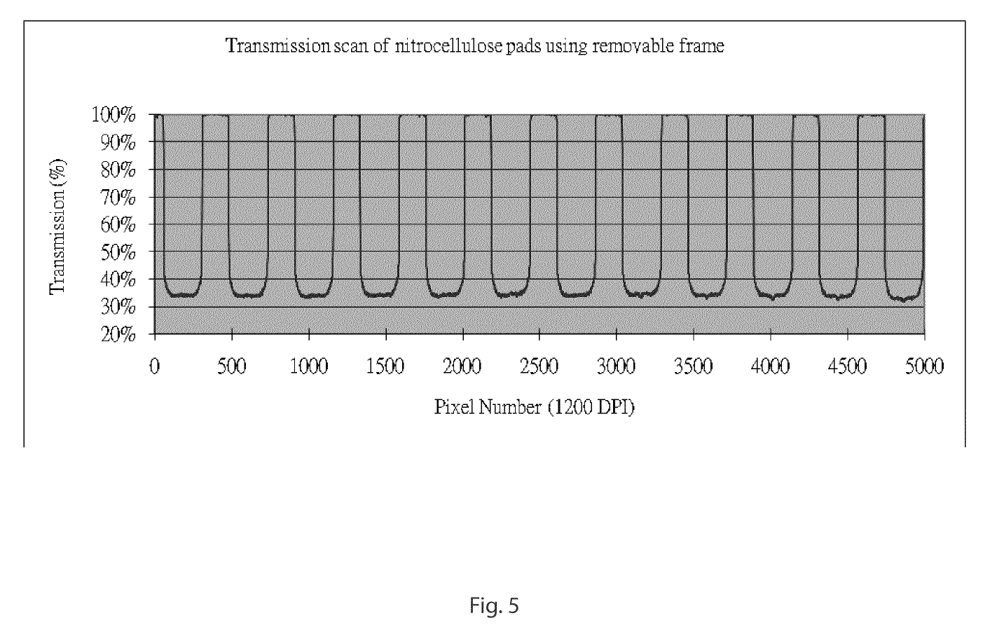

FIG. 5 shows a plot of the transmission percentage of the 5.5 mm diameter nitrocellulose pads using the removable silicone rubber frame. The peaks and valleys in the transmission curves are reduced over those in FIG. 4. Improvements are seen in both the intra-pad uniformity as well as the pad-to-pad uniformity. Nitrocellulose was dispensed and spread using 3 shots of 1.5 microliters of a 3% nitrocellulose solution. The substrate was controlled at 15.5 C and the room temperature was 20.5 C at 60% relative humidity.

### DETAILED DESCRIPTION OF THE FIGURES

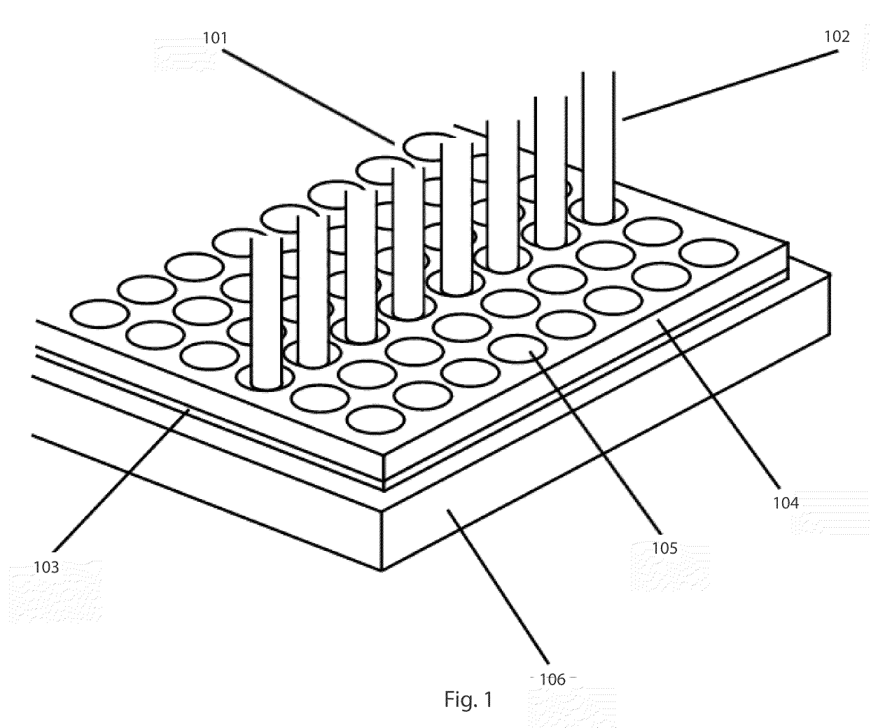

In FIG. 1, a diagram of the dispensing setup is disclosed. An 8-channel dispensing head 101, comprising of eight hypodermic needles 102, is mounted on an XYZ robot such that the head 101 is free to move along the X, Y and Z axis' and the substrate 103 is stationary. A 3mm silicone rubber frame 104 is placed on top of the substrate and dispensing is performed inside the holes 105 of the frame 104. During dispensing and spreading, the needles 102 are approximately 0.4 mm from the substrate 103 surface.

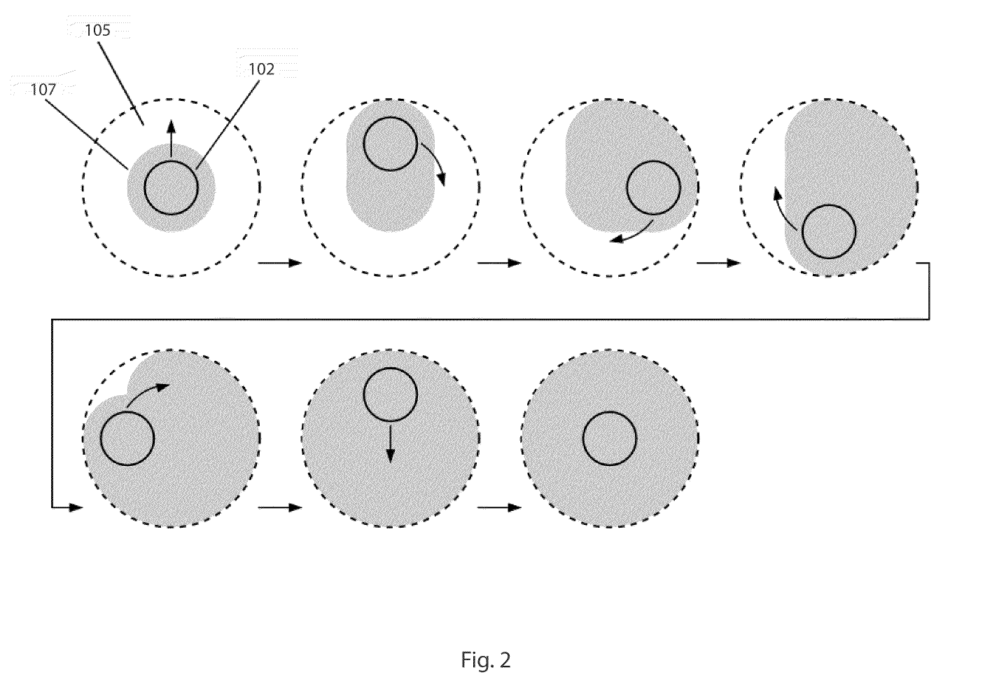

In FIG. 2, a representation of a program that will spread the solution to form a singular pad is disclosed. Two “shots” of 1.5 microliters of solution 107 are injected at different points within the program to create a singular pad. 1.5 microliters of solution 107 is dispensed simultaneously from each of the 8-channels 102 into their corresponding holes 105 of the silicone rubber frame 104. The XYZ robot is programmed so that the solution 102 is spread to form a 5.5 mm diameter circle. Another 1.5 microliters of solution 102 is dispensed in the center of the circle to complete the pad. When the nitrocellulose is dry, the silicone rubber frame 104 is removed.

The first three to four pads make up the pre-print pads and establish consistent dispensing for the remaining pads on the substrate. Pre-print pads can be printed on a separate substrate.

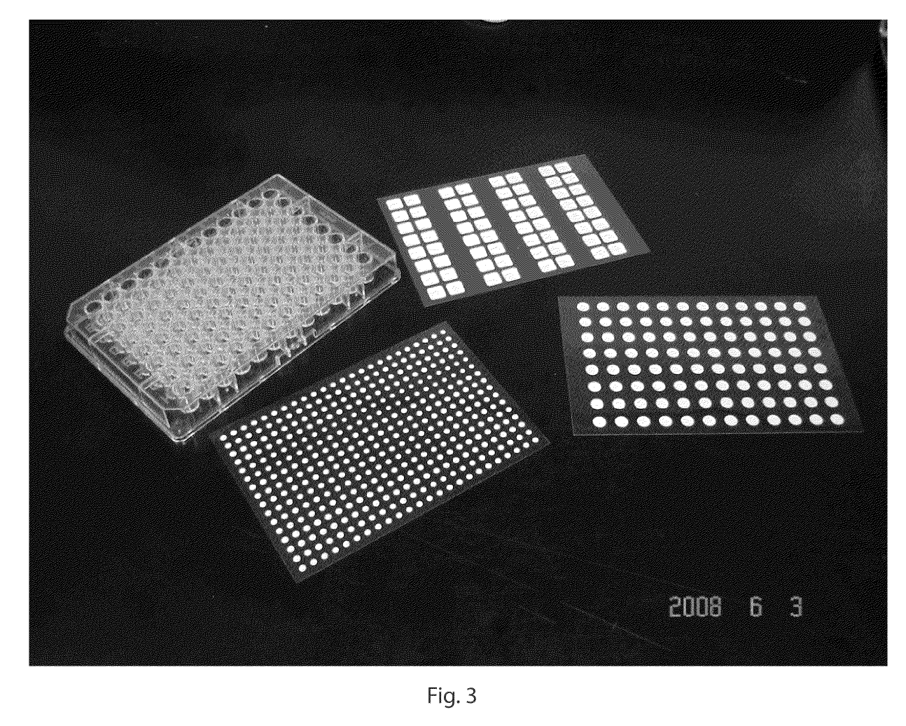

In FIG. 3, a photograph of 3 variations of substrates with nitrocellulose pads created using the disclosed method is disclosed. For comparison purposes a 96 well microtiter plate (top left) is shown side-by-side. Substrates shown are a 96, 5.5 mm diameter dots at a 9 mm pitch (bottom left), a 64, 7 mm×7 mm rounded square pads at a 9 mm pitch (top right) and a 384, 2.5 mm diameter dots at a 4.5 mm pitch (bottom right).

FIG. 4 shows a plot of the transmission percentage of the 5.5 mm diameter nitrocellulose pads when not using the cover 104. A row of 9 pads was scanned using a transparency scanner and the data converted to transmission percentage. The nitrocellulose pads show peaks and valleys within the pad itself, typically with the center at a higher percentage transmission.

FIG. 5 shows a plot of the transmission percentage of the 5.5 mm diameter nitrocellulose pads using the removable silicone rubber frame 104. The peaks and valleys in the transmission curves are reduced over those in FIG. 4. Improvements are seen in both the intra-pad uniformity as well as the pad-to-pad uniformity. Nitrocellulose was dispensed and spread using 3 shots of 1.5 microliters of a 3% nitrocellulose solution. The substrate was controlled at 15.5 C and the room temperature was 20.5 C at 60% relative humidity.

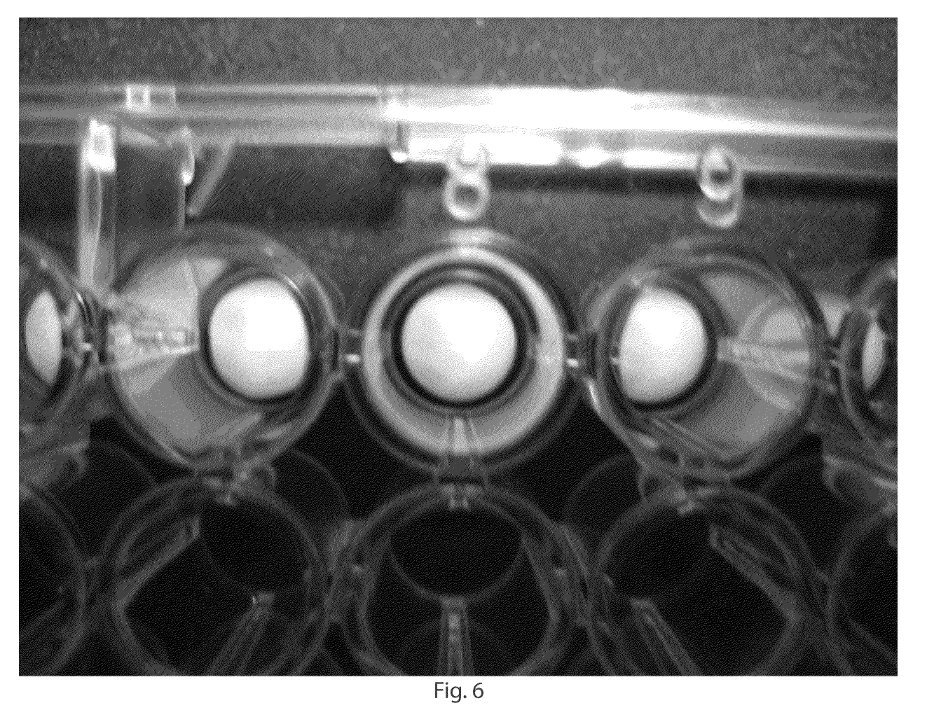

In FIG. 6, a photograph of a 96-well microtiter plate is disclosed. The bottom of the wells are coated with nitrocellulose forming the substrate.

1. A method for creating at least one distinct nitrocellulose-based pad on a substrate by:
a. providing a dispensing station, a dispensed solution, a substrate and a dispensing head;
b. spreading said dispensed solution via said dispensing head in a programmed manner by said dispensing station to define the shape of said nitrocellulose-based pad on said substrate.

2. The method of claim 1 wherein said dispensing station comprises an XYZ robot and a pump.

3. The method of claim 2 wherein said pump is a multi-channel syringe pump.

4. The method of claim 1 wherein said dispensing head is comprised of an array of flat hypodermic syringe needles.

5. The method of claim 1 wherein said dispensing head is comprised of at least one hypodermic syringe needles.

6. The method of claim 1 wherein the substrate is held at a constant temperature.

7. The method of claim 1 wherein said substrate is a micro-titer plate.

8. The method of claim 1 wherein said substrate is a non-planar substrate.

9. The method of claim 8 wherein said non-planar substrate is a flat bottom 96-well micro-titer plate.

10. A method for creating at least one distinct nitrocellulose-based pad on a substrate by:
a. providing a dispensing station, a dispensed solution, a substrate and a dispensing head;
b. providing a removable frame wherein said removable frame is placed on top of said substrate wherein said removable frame comprises at least one opening wherein said opening corresponds to a desired shape of said nitrocellulose-based pad on said substrate;
c. spreading said dispensed solution via said dispensing head in a programmed manner through said removable frame by said dispensing station to define the shape of said nitrocellulose-based pad on said substrate.

11. The method of claim 10 wherein said dispensing station comprises an XYZ robot and a pump.

12. The method of claim 11 wherein said pump is a multi-channel syringe pump.

13. The method of claim 10 wherein said dispensing head is comprised of an array of flat hypodermic syringe needles.

14. The method of claim 10 wherein said dispensing head is comprised of at least one flat hypodermic syringe needle.

15. The method of claim 10 wherein said substrate is held at a constant temperature.

16. The method of claim 10 wherein said removable frame is made with silicone rubber.

17. The method of claim 10 wherein said removable frame is 1 to 5 mm thick.

18. The method of claim 10 wherein said removable frame is 3 to 4 mm thick.

19. The method of claim 10 wherein said removable frame is 3.5 mm thick.

20. The method of claim 10 wherein said substrate is a micro-titer plate.

21. The method of claim 10 wherein said substrate is a non-planar substrate.

22. The method of claim 21 wherein said non-planar substrate is a flat bottom 96-well micro-titer plate.
